(19) United States
(12) Patent Application Publication
(10) Pub. No.: US 2009/0094337 A1
(43) Pub. Date: Apr. 9, 2009

(54) METHOD OF ACCESSING WEB E-MAIL OFF-LINE

(76) Inventor: Eric Wilfred Bruno Dias, Bangalore (IN)

Correspondence Address: IBM CORP (YA);C/O YEE & ASSOCIATES PC, P.O. BOX 802333, DALLAS, TX, 75380, US

(21) Appl. No.: 11/868,784

(22) Filed: Oct. 8, 2007

(51) Int. Cl. G06F 15/16

(52) U.S. Cl. 709/206

(57) ABSTRACT

Computer implemented methods and computer code products provide off-line access to web-based e-mail services. A user of a local data processing system is provided with a local replica of a webmail system. An off-line activity is performed within the local replica. The local replica then utilizes a browser to connect to a webmail server. A synchronization of the local replica with a message file of the webmail server is then performed.

### BACKGROUND OF THE INVENTION

1. Field of the Invention

The present invention relates generally to an improved data processing system. More specifically, the present invention relates to computer implemented methods and computer code products for providing off-line access to web-based e-mail services and providing an off-line interface for use therewith.

2. Description of the Related Art

Webmail, also called web-based e-mail, refers to the implementation of an e-mail client as a web application that allows users to access their e-mail through a web browser. Webmail allows the client to view e-mails directly on the e-mail server within a web browser, without first transferring the e-mail to a local computer application. The e-mail server doubles as the e-mail client. Because e-mail is stored at the e-mail server, and not locally, a webmail client can view and manipulate e-mail from one computer, and later view and manipulate the same e-mail from a different computer. Webmail can therefore be used as an alternative to a desktop-based client, such as Microsoft Outlook®, Mozilla Thunderbird® or Eudora®.

Webmail service or webmail provider typically refers to an e-mail service that is offered through a website, such as Yahoo! Mail®, MSN Hotmail® and Gmail®. Although use of a webmail client—the location of the webmail service—may not required for viewing e-mail, use of the webmail client is generally the preferred, and easiest way to access webmail. Indeed, some webmail providers necessitate use of a webmail client as the only method for users to access their e-mail. Thus, the user must login to the webmail server by means of a browser in order to access and work with the webmail.

However, current implementations of webmail suffer from several drawbacks. Because the mail is implemented in a browser, a user must stay on-line to read and write more than one e-mail. A user attempting to work with e-mails off-line from the webmail application is confronted without an easy method to edit mails they are working on off-line, and must instead copy and paste the text once a connection to the webmail is re-established. Webmail is therefore completely dependent on the continuity and reliability of the network connection. Additionally, webmail usually has speed and functionality limitations not affecting traditional desktop-based clients, partly due to limited capabilities of hypertext transfer markup language (HTML) web pages.

For example, deletion of a message from webmail generally requires the user to “tag” the message within the index of the webmail system. However, these tags are usually lost when the user reads a message. Therefore, current webmail implementations make it impossible for a user to read a suspect message likely to be deleted without deleting already tagged messages or having to re-tag the already tagged messages. This situation makes deletion of multiple messages within the webmail system more awkward than using traditional desktop-based clients.

Therefore, it would be advantageous to have an improved method, apparatus, and computer usable program code for accessing email that overcomes the problems described above.

### SUMMARY OF THE INVENTION

Computer implemented methods and computer code products provide off-line access to web-based e-mail services. A user of a local data processing system is provided with a local replica of a webmail system. An off-line activity is performed within the local replica. The local replica then utilizes a browser to connect to a webmail server. A synchronization of the local replica with a message file of the webmail server is then performed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a diagram illustrating an e-mail messaging system in which illustrative embodiments may be implemented;

FIG. 4 is a process for synchronizing webmail from a webmail server to a client in which illustrative embodiments may be implemented; and

FIG. 5 is a process for synchronizing webmail from a webmail server to a client in which illustrative embodiments may be implemented.

### DETAILED DESCRIPTION OF THE PREFERRED EMBODIMENT

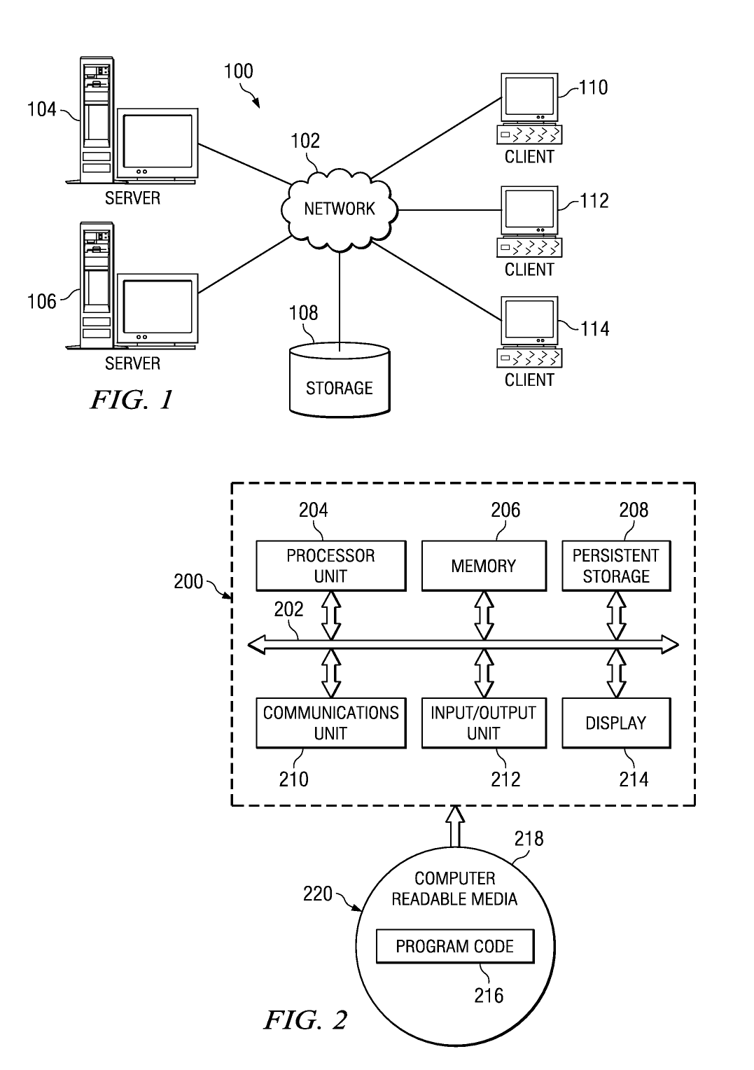

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The present embodiments provide off-line access to web-based e-mail services by creating a local replica of the webmail folders on the user's local device or a desired location such as an external memory storage device that may be attached to the user's local device, and providing the user an interface to access and work with e-mail while off-line. When the user makes an initial connection to the server on a new data processing system, the server may request the user to configure the local replica on the local device. The local replica is encrypted with a key from the server. When the user connects to or disconnects from the webmail client, the local replica and the user's folders on the webmail server are synchronized. Rules for synchronization may be defined by the service provider, the user or both. For example the user may want only certain folders on the server excluding spam, trash etc., to be downloaded onto the local device and only those are to be synchronized.

During the synchronization process, the service provider can perform various different activities which for example allow revenue generation. The webmail provider may provide a plug-in which interfaces with, or is embedded into, the browser allowing the user to work with the local replica with the same look and feel of the service provided on-line. The plug-in is also configured to recognize when the browser connects to and attempts to disconnect from the webmail server. Upon connecting to or attempting to disconnect from the webmail service, the plug-in performs synchronization in order to synchronize the local replica and the user's folders on the webmail server.

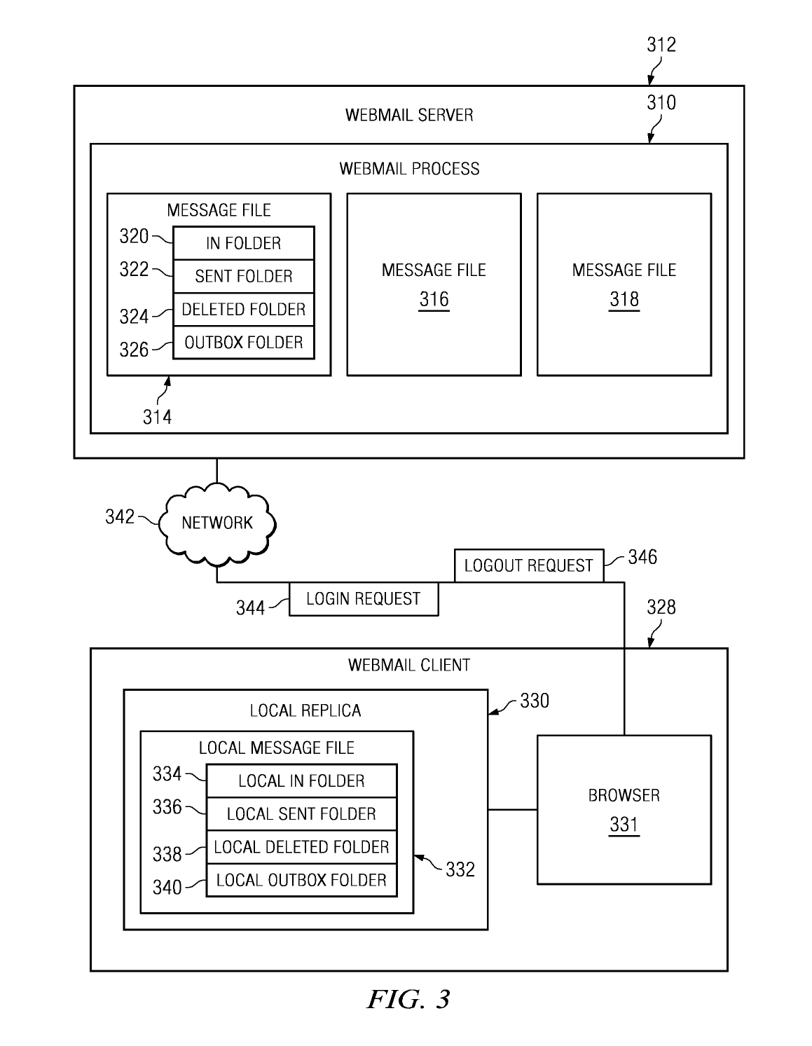

Turning now to FIG. 3, a diagram illustrating an e-mail messaging system is depicted in which illustrative embodiments may be implemented. Webmail process 310 executes on webmail server 312. Webmail process 310 is a software process providing webmail services to clients, such as clients 110, 112, and 114 of FIG. 1. Server 312 is a server such as server 104, 106 of FIG. 1.

Webmail process 310 contains message file 314, message file 316, and message file 318. Each of message files 314, 316, and 318 are associated with a webmail client. Message files 314, 316, and 318 store e-mail messages received by the webmail clients, such as client 110, client 112, and client 114 in FIG. 1, and may be organized into various mailboxes. In one illustrative embodiment, the various mailboxes include, for example, an in folder 320, a sent folder 322, a deleted folder 324, and an outbox folder 326.

Webmail process 310 is used to send e-mails back and forth to different users through webmail server 312. When webmail client 328 connects to webmail server 312, webmail client 328 is allowed to view any messages within message files 314 corresponding to webmail client 328.

Webmail client 328 runs local replica 330. Local replica 330 is a software process that allows webmail client 328 to perform a number of off-line activities, including accessing and manipulating e-mail that has been received by webmail process 310 and synchronized from message file 314 to local replica 330. However, local replica 330 does not allow webmail client 328 to send locally created e-mail, or receive new e-mail without first connecting to webmail process 310. Local replica 330 may be implemented as a plug-in which interfaces with, or embedded into browser 331 allowing webmail client 328 to work with local replica 330 with the same look and feel of the service provided on-line by webmail server 312.

Similar to webmail process 310, local replica 330 contains local message file 332 capable of storing e-mail messages. Local message file 332 may similarly be organized into various mailboxes. In one illustrative embodiment, the various local mailboxes include, for example, a local in folder 334, a local sent folder 336, a local deleted folder 338, and a local outbox folder 340.

Webmail client 328 accesses webmail server 310 over network 342, utilizing browser 331. When webmail client 328 is authenticated, that is when webmail server 310 identifies that webmail client 328 has an account registered with the webmail service provider of webmail server 310, local replica 330 is synchronized with message file 314. Webmail client 320 may be authenticated by receiving a login request 344, including a login name and login password.

New e-mail messages received at in folder 320 are synchronized with a local in folder 334. During synchronization, new mail is not transferred from in folder 320 to a local in folder 334 as in traditional desktop client applications. Rather, the new mail is copied from in folder 320 to local in folder 334, creating message copies, with in folder 320 retaining the original new e-mail. Similarly, e-mail messages within sent folder 322 are synchronized with local sent folder 336.

Deleted folder 324 is synchronized with local deleted folder 338. Message copies that were deleted by webmail client 328 when off-line by utilizing local replica 330 are synchronized, so that the messages in message file 314 are transferred from other folders of message file 314 to deleted folder 324.

Outbox folder 326 is synchronized with local outbox folder 340. Messages created by webmail client 328 when off-line by utilizing local replica 330 are synchronized. The created message is copied from local outbox folder 340 to outbox folder 326.

While connected to webmail server 312, webmail client 328 is provided on-line access to the various mailboxes for message file 314. Messages received, created, deleted, or otherwise manipulated by webmail client 328 are organized directly into the corresponding mailboxes within message file 314.

Upon receiving log out request 346, local replica 330 is again synchronized with message file 314. New e-mail messages received at in folder 320 are synchronized with a local in folder 334. During synchronization, new mail is not transferred from in folder 320 to a local in folder 334 as in traditional desktop client applications. Rather, the new mail is copied from in folder 320 to local in folder 334, creating message copies, with in folder 320 retaining the original new e-mail. Similarly, e-mail messages within sent folder 322 are synchronized with local sent folder 336.

Deleted folder 324 is synchronized with local deleted folder 338. Message copies that were deleted by webmail client 328 when on-line by utilizing webmail process 310 are synchronized, so that the messages in local replica 330 are transferred from other local folders to local deleted folder 338.

Outbox folder 326 is synchronized with local outbox folder 340. Messages created by webmail client 328 when on-line by utilizing webmail process 310 are synchronized. The created messages are copied from outbox folder 326 to local outbox folder 340.

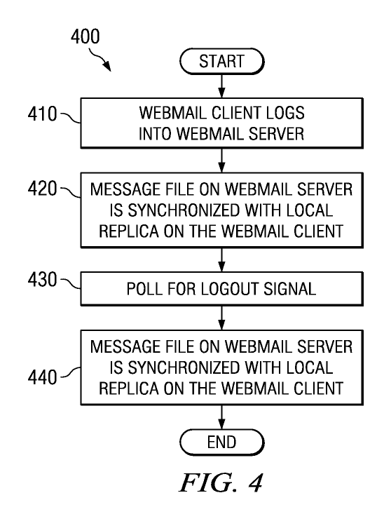

Referring now to FIG. 4, a process for synchronizing webmail from a webmail server to a client is shown in which illustrative embodiments may be implemented. Process 400 is a software process, such as process webmail process 310 of FIG. 3. Process 400 executes on a webmail server, such as webmail server 312 of FIG. 3. Process 400 may be implemented as a plug-in, which interfaces with, or is embedded into a browser allowing a webmail client to work with a local replica having the same look and feel of the service provided on-line by the webmail server.

Once the local plug-in is installed, process 400 begins when a webmail client logs into the webmail server (step 410). Login is accomplished when the webmail client is authenticated, that is when process 400 receives a login request, and identifies that webmail client has an account registered with the webmail service provider of webmail server. The login request can be login request 344 of FIG. 3, and can include a login name and login password of the webmail client.

Responsive to a webmail client logging into the webmail server, process 400 synchronizes the message file on the webmail server that corresponds to the webmail client with a local replica on the webmail client (step 420).

Messages in the various folders of the webmail server's message file are synchronized with their corresponding folders of the webmail client's local replica. New e-mail messages received at the webmail server's in folder are synchronized with the local in folder. During synchronization, new mail is not transferred from the webmail server's in folder to a local in folder as in traditional desktop client applications. Rather, new mail is copied from the webmail server's in folder to the local in folder, creating message copies, with the webmail server's in folder retaining the original new e-mail. Similarly, e-mail messages within the webmail server's sent folder are synchronized with local sent folder.

The webmail server's deleted folder is synchronized with local deleted folder. Message copies that were deleted locally by the webmail client when off-line by utilizing the local replica are synchronized, so that the messages in the webmail server's message file are transferred from the folder in which they were previously contained to the webmail server's deleted folder.

The webmail server's outbox folder is synchronized with local outbox folder. Messages created locally by the webmail client when off-line by utilizing the local replica are synchronized. The locally created message is copied from the local outbox folder to the webmail server's outbox folder. The webmail server can then send the copy of the locally created message.

Process 400 then polls for a logout signal from the webmail client (step 430). Responsive to receiving a logout signal from the webmail client, process 400 again synchronizes the webmail server's message file corresponding to the webmail client with the local replica on the webmail client (step 440), with the process terminating thereafter. New e-mail messages received at the webmail server's in folder are synchronized with the local in folder.

During synchronization, new mail is not transferred from the webmail server's in folder to the local in folder as in traditional desktop client applications. Rather, the new mail is copied from the webmail server's in folder to local in folder, creating message copies, with the webmail server's in folder retaining the original new e-mail. Similarly, e-mail messages within the webmail server's sent folder are synchronized with local sent folder.

The webmail server's deleted folder is synchronized with local deleted folder. Message copies that were deleted by the webmail client when on-line by utilizing the webmail process are synchronized, so that the messages in the local replica are transferred from other local folders to the local deleted folder.

The webmail server's outbox folder is synchronized with the local outbox folder. Messages created by the webmail client when on-line by utilizing the webmail process are synchronized. The created message is copied from the webmail server's outbox folder to local outbox folder. Similarly, e-mail messages within the webmail server's sent folder are synchronized with local sent folder.

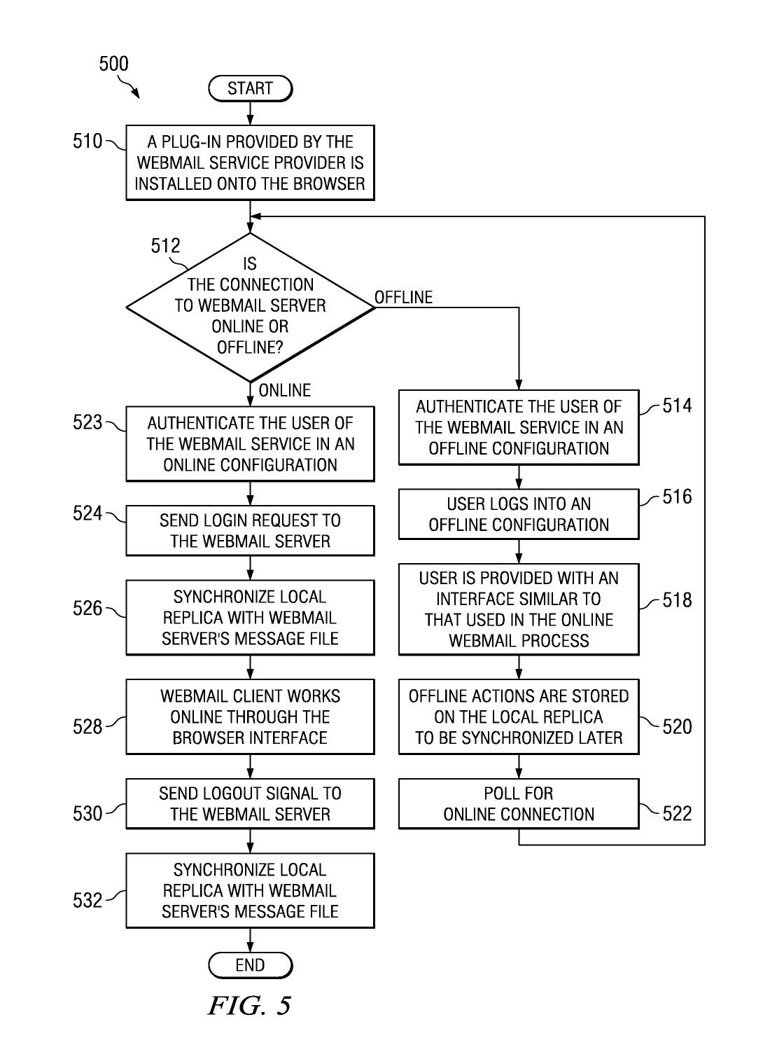

Referring now to FIG. 5, a process for synchronizing webmail from a webmail server to a client is shown in which illustrative embodiments may be implemented. Process 500 is a software process, such as process local replica 328 of FIG. 3. Process 500 executes on a webmail client, such as webmail client 328 of FIG. 3. Process 500 may be implemented as a plug-in which interfaces with, or embeds into a browser allowing a webmail client to work with a local replica having the same look and feel of the service provided on-line by the webmail server.

Prior to the execution of process 500, a plug-in provided by the webmail service provider is installed onto the browser (step 510). This is a one time process, and the plug-in automatically identifies the different types of browsers and associates itself with the various browsers on the user's device.

Process 500 then begins by detecting whether the connection required to the webmail server is off-line or on-line (step 512). The connection is on-line when the webmail client is logged into the webmail server. The connection is off-line when the webmail client is logged out of the webmail server.

Responsive to process 500 identifying that connection to the webmail server is off-line (“off-line” at step 512), process 500 authenticates the user of the webmail service in an off-line configuration (step 514). Process 500 may require the user to log into an off-line configuration (step 516), similar to logging into the on-line configuration. However, in one illustrative embodiment, process 500 may be executing on a secure system is secure, and logging into the local replica may be disabled.

Process 500 provides the user with an interface similar to that used in the on-line webmail process (step 518). This interface may be equivalent in look and feel to the original graphical user interface provided to the webmail client when the webmail server is accessed in the on-line configuration. The interface allows a user to perform any action that would normally take place through the webmail server, including without limitation composition of new e-mail and manipulation of previously received mail.

Any action made by the user while in the off-line configuration, including without limitation the composition of new e-mail and the manipulation of previously received mail, will be stored on the local replica to be synchronized with the webmail server during a subsequent on-line configuration (step 520). Process 500 can then poll for an on-line connection (step 522), retuning to step 512.

Responsive to process 500 identifying that connection to the webmail server is on-line (“on-line” at step 512), process 500 authenticates the user of the webmail service in an on-line configuration (step 523).

Process 500 accesses the webmail server by sending a login request to the webmail server (step 524). The login request can include a login name and login password. When process 500 is authenticated by the webmail server, that is when webmail process 310 in FIG. 3 identifies that webmail client running process 500 has an account registered with the webmail service provider of webmail server, process 500 synchronizes local replica with the webmail server's message file that corresponds to the webmail client (step 526).

In one embodiment, process 500 synchronizes the webmail server's message file with the local replica by being configured to automatically send and receive mails after completing work on the local replica without going on-line to the server. Synchronization of the local replica with the mail server ensures that the contents on the server and the local replica are identical. Also, after connecting and synchronizing with the e-mail server, the server is configured to perform a “send” of all messages that are in the sent folder.

After process 500 synchronizes the webmail server's message file with the local replica, the webmail client works on-line through the browser interface (step 528) provided by the webmail server. While connected to webmail server, process 500 is provided on-line access to the various mailboxes for webmail server's message file. Messages received, created, deleted, or otherwise manipulated by webmail client are organized directly into the corresponding mailboxes within message file on the webmail server.

When the webmail client has concluded the on-line session, process 500 sends a logout signal to the webmail server (step 530). Responsive to sending the logout signal, process 500 again synchronizes the local replica with the webmail server's message file corresponding to the webmail client (step 532), with the process terminating thereafter.

Thus, the illustrative embodiments described herein provide improved systems, methods and computer code products for providing off-line access to web-based e-mail services by creating a local replica of the webmail folders on a user's local device, and providing the user an interface to access and work with e-mail while off-line. When the user makes an initial connection to the server on a new data processing system, the server may request the user to configure the local replica on the local device. The local replica is encrypted with a key from the server. When the user connects to or disconnects from the webmail client, the local replica and the user's folders on the webmail server are synchronized. Rules for synchronization may be defined by the service provider, the user or both. For example the user may want only certain folders on the server to be downloaded onto the local device and only those are to be synchronized. Examples if items that may be excluded are spam and trash folders.

During the synchronization process, the service provider can perform various different activities which for example allow revenue generation. The webmail provider may provide a plug-in which interfaces with, or embedded into the browser allowing the user to work with the local replica with the same look and feel of the service provided on-line. The plug-in is also configured to recognize when the browser connects to and attempts to disconnect from the webmail server. Upon connecting to or attempting to disconnect from the webmail service, the plug-in performs synchronization in order to synchronize the local replica and the user's folders on the webmail server.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for accessing webmail, the method comprising:
providing a user with a local replica;
performing at least one off-line activity within the local replica;
connecting through a browser to a webmail server; and
performing a first synchronization of the local replica with a message file of the webmail server.

2. The computer implemented method of claim 1, wherein the local replica comprises a first interface having the same look and feel of a second interface provided by the webmail server through the browser.

3. The computer implemented method of claim 1, wherein the local replica comprises a plug-in which interfaces with the browser.

4. The computer implemented method of claim 1, wherein the at least one off-line activity is selected from the group consisting of creating an e-mail and deleting an e-mail.

5. The computer implemented method of claim 1, wherein the first synchronization comprises synchronizing a local in folder with a server in folder, synchronizing a local sent folder with a server sent folder, synchronizing a local deleted folder with a server deleted folder, and synchronizing a local outbox folder with a server outbox folder.

6. The computer implemented method of claim 1 further comprising:
performing at least one on-line activity within the browser.

7. The computer implemented method of claim 6, wherein the at least one on-line activity is selected from the group consisting of creating an e-mail and deleting an e-mail.

8. The computer implemented method of claim 5 further comprising:
sending a logout signal to the webmail server; and
responsive to sending the logout signal, performing a second synchronization of the local replica with a message file of the webmail server.

9. A computer implemented method for accessing webmail, the method comprising:
connecting through a browser to a webmail server;
performing at least one on-line activity within the browser connected;
sending a logout signal to the webmail server; and
responsive to sending the logout signal, performing a first synchronization of a message file of the webmail server with a local replica.

10. The computer implemented method of claim 9, wherein the at least one on-line activity is selected from the group consisting of creating an e-mail and deleting an e-mail.

11. The computer implemented method of claim 9, wherein the local replica comprises a first interface having the same look and feel of a second interface provided by the webmail server through the browser.

12. The computer implemented method of claim 1, wherein the local replica comprises a plug-in which interfaces with the browser.

13. The computer implemented method of claim 9, wherein the first synchronization comprises synchronizing a local in folder with a server in folder, synchronizing a local sent folder with a server sent folder, synchronizing a local deleted folder with a server deleted folder, and synchronizing a local outbox folder with a server outbox folder.

14. A computer program product comprising:
a computer readable medium having computer usable program code for accessing webmail, the computer program product comprising:
computer usable program code for providing a user with a local replica;
computer usable program code for performing at least one off-line activity within the local replica;
computer usable program code for connecting through a browser to a webmail server; and
computer usable program code for performing a first synchronization of the local replica with a message file of the webmail server.

15. The computer program product of claim 14, wherein the local replica comprises a first interface having the same look and feel of a second interface provided by the webmail server through the browser.

16. The computer program product of claim 14, wherein the local replica comprises a plug-in which interfaces with the browser.

17. The computer program product of claim 14, wherein the at least one off-line activity is selected from the group consisting of creating an e-mail and deleting an e-mail.

18. The computer program product of claim 14, wherein the first synchronization comprises synchronizing a local in folder with a server in folder, synchronizing a local sent folder with a server sent folder, synchronizing a local deleted folder with a server deleted folder, and synchronizing a local outbox folder with a server outbox folder.

19. The computer program product of claim 14 further comprising:
computer usable program code for performing at least one on-line activity within the browser, wherein the at least one on-line activity is selected from the group consisting of creating an e-mail and deleting an e-mail.

20. The computer program product of claim 14 further comprising:
computer usable program code for sending a logout signal to the webmail server; and
computer usable program code for, responsive to sending the logout signal, performing a second synchronization of the local replica with a message file of the webmail server.
